(19) United States
(12) Patent Application Publication
(10) Pub. No.: US 2008/0295600 A1
(43) Pub. Date: Dec. 4, 2008

(54) Ultrasound Mapping System By Transmission, Using at Least One Piezoelectric Film

(75) Inventor: Didier Simonet, Leguevin (FR)

Correspondence Address: THELEN LLP, P. O. BOX 640640, SAN JOSE, CA, 95164-0640, US

(73) Assignee: EUROPEAN AERONAUTIC DEFENCE AND SPACE COMPANY EADS, Paris (FR)

(21) Appl. No.: 11/660,826

(22) PCT Filed: Aug. 23, 2005
(86) PCT No.: PCT/FR2005/050681

§ 371 Date: Jul. 3, 2008

(30) Foreign Application Priority Data
Aug. 23, 2004 (FR) 0451883

(51) Int. Cl. G01N 29/26

(52) U.S. Cl. 73/602

(57) ABSTRACT

Ultrasound mapping system by transmission, using at least one piezoelectric film.

This system comprises an ultrasonic transmitter (16) and an ultrasonic receiver, placed on either side of an object (10). The transmitter is displaceable and encoded in position, the receiver comprises at least one piezoelectric film (14) and the system further comprises means (20) for processing the signals provided by the film when the latter receives ultrasonic waves, so as to map the object.

### TECHNICAL FIELD

The present invention relates to an ultrasound mapping system by transmission.

It is particularly applicable to non-destructive testing of objects such as mechanical parts for example.

### STATE OF THE PRIOR ART

In the field of non-destructive testing, ultrasound techniques are well known. There are various mapping means for implementing these techniques.

In a known way, in the field of ultrasonic testing by reflection, a single ultrasonic sensor is used and its position is encoded via a mechanical system which for example comprises an arm or a ramp, in order to retranscribe an “image” of a part which is being inspected. In this case, the amplitude or the travel time of an ultrasonic echo is determined, for a given position of the sensor relative to the part.

In the field of ultrasonic testing by transmission, it is known how to use an ultrasonic transmitter and an ultrasonic receiver which are separated from each other: they are positioned on either side of the inspected part. In this case, the transmitter and the receiver are displaced on either side of this part simultaneously, via a mechanical system which is encoded in position.

Ultrasound mapping systems exist for any type of ultrasonic inspection: inspection in immersion, by contact, by water jet, by coupling via air, by laser or via an Electro-Magneto-Acoustic Transducer (EMAT).

However, ultrasonic inspection by transmission is often not possible because very often it is difficult to access the area intended to be inspected and to implement such an inspection technique.

### DISCUSSION OF THE INVENTION

The object of the present invention is to find a remedy to the previous drawbacks.

Its object is an ultrasound mapping system of an object by transmission, this system comprising a transmitter of ultrasonic waves and a receiver of ultrasonic waves, which are placed on either side of the object, the system being characterized in that:
the transmitter is displaceable relatively to the object and encoded in position,
the receiver is fixed relatively to the object and comprises at least one piezoelectric film, and
the system further comprises electronic means for processing electrical signals provided by the piezoelectric film when this piezoelectric film receives ultrasonic waves, so as to map the object.

According to a first particular embodiment of the system object of the invention, the piezoelectric film is positioned on a support.

According to a second particular embodiment, the piezoelectric film is placed against a first face of the object and the ultrasound transmitter is displaceable, facing a second face of the object which is opposite to the first face.

The system, object of the invention, may comprise a plurality of piezoelectric films which are positioned beside each other in order to increase the mapped surface area.

According to a preferred embodiment of the system, object of the invention, each piezoelectric film is of the PVDF type or copolymer type.

### SHORT DESCRIPTION OF THE DRAWINGS

The present invention will be better understood upon reading the description of exemplary embodiments given hereafter, as purely indicative and by no means limiting, with reference to the appended drawings wherein:

FIG. 1 is a schematic view of a particular embodiment of the system, object of the invention, allowing inspection by transmission in immersion, and

FIG. 2 is a schematic view of another particular embodiment of the system, object of the invention, allowing an inspection by transmission and contact.

### DETAILED DISCUSSION OF PARTICULAR EMBODIMENTS

An ultrasound mapping system according to the invention uses a piezoelectric film which preferably is of the PVDF type or copolymer type. Let us recall that the acronym PVDF designates polyvinylidene fluoride.

Such a system allows inspections by transmission of ultrasound to be carried out when these inspections are difficult or even impossible to apply, for example because of problems for accessing the area to be inspected and/or of problems of robotics or of setting up a mapping system.

The piezoelectric film used is either positioned on a support, which may be a glass plate placed in a tank or on any other rigid surface, or directly stuck on a face of a part to be inspected.

This film is used as an ultrasonic receiver and is connected to an ultrasound inspection apparatus.

Ultrasound transmission (for example by contact, by means of a EMAT, in immersion, by coupling via air or by laser) is obtained by a suitable system which is encoded in position.

Thus, a physical quantity from the ultrasonic receiver, i.e. the piezoelectric film, is associated with every position of the ultrasonic transmission point. A map of the part which is inspected can thereby be obtained.

The size of such a mapping is of course limited by the size of the piezoelectric film which is used and/or by the system for scanning the part by means of the ultrasonic transmitter.

In order to increase the inspected surface area, several piezoelectric films may be used and these films may be placed one beside the other, for example by juxtaposing them on the support mentioned above or by sticking them one beside the other on a face of the inspected part.

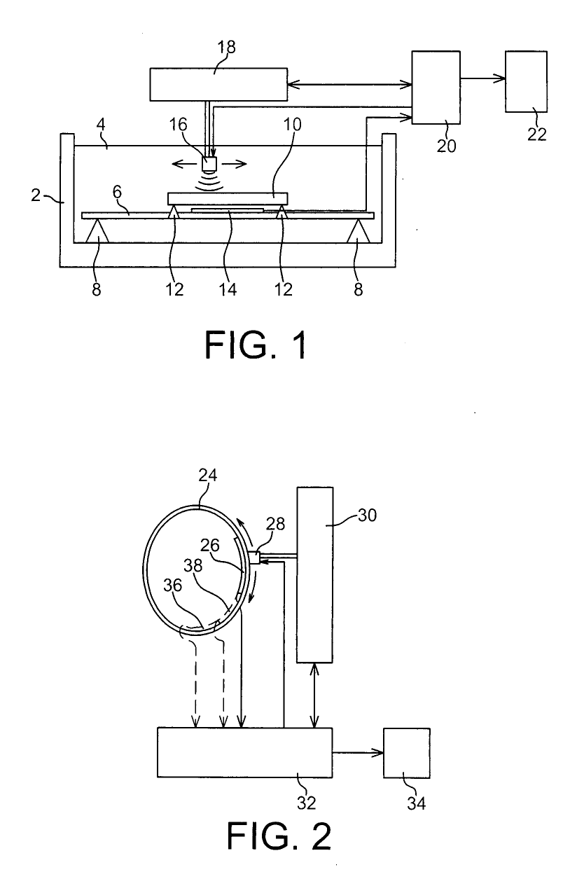

The examples of FIGS. 1 and 2 schematically illustrate the foregoing.

An example of the system of the invention is schematically illustrated by FIG. 1 and relates to an ultrasonic inspection by transmission, in immersion.

A tank 2 which is filled with water 4 is seen in this FIG. 1. A glass plate 6 rests horizontally on the bottom of the tank 2 via supports 8.

A part to be inspected 10 rests on the glass plate 6 via supports 12, so that a gap exists between the lower face of the part and this plate 6.

A PVDF type or copolymer type piezoelectric film 14 is positioned in this gap, against the glass plate 6. Like this plate, the film is therefore fixed relatively to the part 10.

An ultrasonic transmitter 16 is positioned in the water, facing the upper face of the part 10. This ultrasonic transmitter is fixed to displacement means 18 which allow it to be displaced facing the part and to scan the latter with an ultrasonic beam.

With these displacement means 18, the position of the ultrasonic transmitter 16 may be known at any instant so that the latter is encoded in displacement (it is also said that it is encoded in position).

Thus, for any position occupied by the transmitter, the ultrasonic beam from this transmitter interacts with the part 10, and the piezoelectric film 14 detects the ultrasonic waves transmitted by this part and provides an electrical signal corresponding to the position occupied by the transmitter 16.

Electronic control and processing means 20 are provided for
controlling the displacement means 18 as well as the ultrasonic transmitter 16,
receiving the electric signals transmitted by the piezoelectric film 14, and
processing these signals in order to obtain an ultrasound mapping of the inspected part.

These control and processing means 20 are provided with display means 22 with which the obtained ultrasound mapping may be viewed.

FIG. 2 schematically illustrates another example of the invention, allowing ultrasonic inspection of a part by transmission and contact.

In this case, the ultrasonic transmitter and the ultrasonic receiver (piezoelectric film) are placed on either side of the part to be inspected, the receiver being in contact with the latter.

In the example illustrated in FIG. 2, the part to be inspected 24 has the shape of a tube which is seen in a cross-sectional view. The piezoelectric electric film 26 is stuck against the inner wall of this tube, in the area which is intended to be inspected.

A ultrasonic probe 28 is used as ultrasonic transmitter. This probe 28 is fixed to displacement means 30 with which this probe may be displaced on the outer wall of the tube, facing the piezoelectric film, and in the whole area to be inspected. These means 30 also allow the position of the probe to be monitored which is therefore still encoded in displacement.

Electronic control and processing means 32 are provided for
controlling the displacement means 30 and the ultrasonic probe 28,
receiving the electric signals from the piezoelectric film 26 when the latter receives ultrasonic waves transmitted by the part (during the interaction of this part with the ultrasonic beam transmitted by the probe 28), and
processing these signals in order to obtain ultrasound mapping of the inspected area of the part.

Display means 34 are further associated with these means 32 for viewing this map.

If the intention is to increase the inspection surface area, piezoelectric films such as films 36 and 38, may be added to the film 26, and these films 36 and 38 may be stuck against the inner wall of the part by juxtaposing all the films.

Displacement means 30 are then provided for displacing the ultrasonic probe 26 over the whole area which results from this juxtaposition, facing the area occupied by all the films.

The films which were added, are also connected to the electronic processing and control means 32, so that ultrasound mapping may be obtained of the part 24 in a vaster area.

Of course, the surface area of the inspected area may be increased in the same way in the example of FIG. 1, by juxtaposing several piezoelectric films on the glass plate 6 facing the inspected part, by allowing the ultrasonic transmitter 16 to scan the inspected part facing the whole of the piezoelectric films, and by connecting the latter to the control and processing means 20 in order to obtain ultrasound mapping of the part in an area of larger surface area.

1. An ultrasound mapping system of an object by transmission, this system comprising an ultrasonic transmitter and an ultrasonic receiver, which are placed on either side of the object, this system being characterized in that:
the transmitter is displaceable relatively to the object and encoded in position,
the receiver is fixed relatively to the object and comprises at least one piezoelectric film, and
the system further comprises electronic means for processing the electric signals provided by the piezoelectric film when this piezoelectric film receives ultrasonic waves, in order to map the object.

2. The system according to claim 1, wherein the piezoelectric film is positioned on a support.

3. The system according to claim 1, in which the piezoelectric film is placed against a first face of the object and the ultrasonic transmitter is displaceable facing a second face of the object, which is opposite to the first face.

4. The system according to claim 1, comprising a plurality of piezoelectric films which are positioned beside each other in order to increase the mapped surface.

5. The system according to claim 1, wherein each piezoelectric film is of the PVDF type or copolymer type.
